(19) United States
(12) Patent Application Publication
(10) Pub. No.: US 2025/0153433 A1
(43) Pub. Date: May 15, 2025

(54) RELEASE FILM REPLACING DEVICE AND 3D PRINTING APPARATUS

(71) Applicant: Shenzhen Creality 3D Technology Co., Ltd., Shenzhen (CN)

(72) Inventors: Chun CHEN, Shenzhen (CN); Shuquan CHEN, Shenzhen (CN); Xiaochan CHEN, Shenzhen (CN)

(21) Appl. No.: 18/832,558

(22) PCT Filed: Jan. 18, 2023
(86) PCT No.: PCT/CN2023/072951

§ 371 Date: Jul. 24, 2024

(30) Foreign Application Priority Data
Jan. 24, 2022 (CN) 202210081932.8

(51) Int. Cl. B29C 64/245; B28B 1/00; B29C 64/129; B33Y 30/00; B65H 18/10

(52) U.S. Cl. CPC B29C 64/245; B65H 18/103; B28B 1/001; B29C 64/129; B33Y 30/00

(57) ABSTRACT

The present invention relates to a release film replacing device, which comprises a winding assembly and a compression assembly. The winding assembly comprises a first reel and a second reel, wherein the first reel and the second reel are disposed opposite each other and are spaced apart from each other, both the first reel and the second reel are rotatably connected to a frame, the first reel winds up a first end of a release film, and the second reel winds up a second end of the release film. When the second reel is rotated about its own axis in a first direction, the first end of the release film can be unwound and the second end thereof can be wound.

### CROSS-REFERENCE TO RELATED APPLICATIONS

The present application is the national stage application of the international patent application No. PCT/CN2023/072951, filed on Jan. 18, 2023, which is incorporated herein by reference in its entirety.

### TECHNICAL FIELD

The present application relates to the technical field of 3D printing, and in particular, to a release film replacing device and a 3D printing apparatus.

### BACKGROUND

With the development of 3D printing technology, LCD light-curing 3D printing technology has emerged. The existing LCD light-curing 3D printing technology mainly extends a forming platform of a light-curing printing device into a liquid printing material inside a filament tank of the printing device and irradiates the liquid printing material through an ultraviolet light source so that the liquid printing material achieves light curing between a release film and the forming platform and finally forms a required forming model on the forming platform. Since the release film needs to be separated from the model surface every time a layer is printed during the light-curing forming process, it is highly susceptible to wear and tear and must be replaced frequently.

### SUMMARY

In view of the foregoing, it is necessary to provide a release film replacing device to solve the technical problems that the disassembly/assembly process is cumbersome when the release film needs to be replaced and the entire replacement process is time-and labor-consuming.

The present application provides a release film replacing device, including: a winding assembly, where the winding assembly includes a first reel and a second reel; the first reel and the second reel are oppositely spaced apart and both configured to be rotatably connected to a rack, the first reel is configured to wind a first end of a release film, and the second reel is configured to wind a second end of the release film; and when the second reel rotates about an axis thereof along a first direction, the first end of the release film is unwound relative to the first reel and the second end of the release film is wound relative to the second reel.

In an embodiment, the winding assembly further includes a fixed plate connected to the rack, and the first reel and the second reel are installed on the same side of the fixed plate; and the second end of the release film is capable of passing over the fixed plate and being wound around the second reel via a side of the fixed plate away from the first reel.

In an embodiment, a compression assembly is further included, and the compression assembly is arranged on a side of the release film away from the winding assembly and connected to the fixed plate; and the compression assembly is capable of moving close to or far away from the release film.

In an embodiment, the compression assembly includes a compression frame; the release film replacing device further includes a first driving assembly installed on the fixed plate and connected to the compression frame; and the first driving assembly is configured to drive the compression frame to move close to or farther away from the release film.

In an embodiment, the first driving assembly includes a first driving member, a lead screw nut, and a lifting lead screw; the first driving member is installed on the fixed plate, the lead screw nut is fixedly connected to the compression frame, one end of the lifting lead screw is connected to a power take-off end of the first driving member, and the other end of the lifting lead screw extends through the lead screw nut and is threadedly connected thereto; and the first driving member is configured to drive the lifting lead screw to rotate about an axis thereof, so as to drive the compression frame to move close to or farther away from the release film.

In an embodiment, the number of the lifting lead screws is a plurality and the plurality of lifting lead screws are spaced apart along length and width directions of the fixed plate; and the first driving assembly further includes a synchronous mechanism installed on the fixed plate, the synchronous mechanism is connected to the first driving member and each of the plurality of lifting lead screws, and each of the plurality of lifting lead screws is capable of being driven by the synchronous mechanism to rotate about an axis thereof.

In an embodiment, the synchronous mechanism includes a first master synchronous wheel, a plurality of first slave synchronous wheels, and a first synchronous belt; the first master synchronous wheel and the plurality of first slave synchronous wheels are spaced apart, the first master synchronous wheel is sleeved and fixed on the power take-off end of the first driving member, each of the plurality of first slave synchronous wheels is sleeved and fixed on an end of one of the lifting lead screws away from the compression frame, the first master synchronous wheel and the plurality of first slave synchronous wheels are capable of tensioning the first synchronous belt and driving the first synchronous belt to make a closed circular motion along a second direction.

In an embodiment, the first driving assembly further includes a guide member connected between the fixed plate and the compression frame, the compression frame is slidably connected to the guide member, and when the compression frame moves close to or farther away from the release film, the compression frame is capable of sliding relative to the guide member.

In an embodiment, the compression assembly further includes a silicone ring fixedly connected to a side of the compression frame close to the release film, and a side of the silicone ring away from the compression frame is configured to compress the release film.

In an embodiment, the compression assembly further includes a positioning pin, one end of the positioning pin is fixedly connected to the compression frame, and the other end of the positioning pin extends through the silicone ring and a positioning hole in the release film.

In an embodiment, a second driving assembly is further included, and the second driving assembly is installed on the fixed plate, connected to an end of the second reel, and capable of driving the second reel to rotate about an axis thereof along the first direction.

In an embodiment, the second driving assembly includes a second driving member, a second master synchronous wheel, a second slave synchronous wheel, and a second synchronous belt; the second driving member is installed on the fixed plate, the second master synchronous wheel and the second slave synchronous wheel are oppositely spaced apart, the second master synchronous wheel is sleeved and fixed on a power take-off end of the second driving member, and the second slave synchronous wheel is sleeved and fixed on an end of the second reel; and the second master synchronous wheel and the second slave synchronous wheel are capable of tensioning the second synchronous belt and being driven by the second driving member to drive the second synchronous belt to make a closed circular motion along the first direction.

In an embodiment, a controller is further included, and the controller is connected to the compression assembly and the second driving assembly; and when the compression assembly moves away from the release film, the controller controls the second driving assembly to drive the second reel to rotate about an axis thereof along the first direction.

In an embodiment, a screen assembly is further included, and the screen assembly is arranged between the release film and the fixed plate and includes a printing screen; and a side of the printing screen is provided with a mounting plate protruding along a thickness direction thereof, a first mounting slot is formed in the fixed plate, and the mounting plate is capable of being inserted into the first mounting slot and fixedly connected to a wall of the first mounting slot.

In an embodiment, the screen assembly further includes a screen cushion block, a glass support plate, and a screen pressure block arranged in sequence along a vertical direction, and the screen cushion block, the glass support plate, and the screen pressure block are disposed between the printing screen and the fixed plate; and one side of the screen cushion block is fixedly connected to the fixed plate, the other side of the screen cushion block is fixedly connected to the screen pressure block, and the glass support plate is capable of being pressed by the screen pressure block against the screen cushion block.

In an embodiment, a second mounting slot is formed on a side of the screen cushion block close to the screen pressure block, a third mounting slot is formed on a side of the screen pressure block close to the screen cushion block, and side edges of the glass support plate are capable of being accommodated and clamped in the second mounting slot and the third mounting slot.

In an embodiment, the screen assembly further includes a PVC sheet arranged on a side of the printing screen away from the screen pressure block and connected to the printing screen.

The present application further provides a 3D printing apparatus capable of solving at least one of the above technical problems.

The 3D printing apparatus provided by the present application includes the above-mentioned release film replacing device and a rack, and the release film replacing device is slidably connected to the rack.

### BRIEF DESCRIPTION OF DRAWINGS

FIG. 1 is a schematic diagram of a release film replacing device provided by an embodiment of the present application;

FIG. 2 is an exploded view of the release film replacing device shown in FIG. 1;

FIG. 3 is a top view of the release film replacing device shown in FIG. 1.

FIG. 4 is an A-A sectional view of the release film replacing device shown in FIG. 3;

FIG. 5 is an enlarged view of a partial structure B of the release film replacing device shown in FIG. 4;

FIG. 6 is an enlarged view of a partial structure C of the release film replacing device shown in FIG. 4;

FIG. 7 is a schematic diagram of mounting a screen cushion block, a glass support plate, and a screen pressure block in the release film replacing device shown in FIG. 1;

FIG. 8 is a schematic diagram of a compression assembly in the release film replacing device shown in FIG. 1 moving close to a release film;

FIG. 9 is a schematic diagram of the compression assembly in the release film replacing device shown in FIG. 1 moving away from the release film;

FIG. 10 is a schematic diagram of mounting the release film replacing device shown in FIG. 1 on a 3D printing apparatus.

Reference signs: 110—winding assembly; 111—first reel; 112—second reel; 113—fixed plate; 1131—first mounting slot; 114—support arm; 1141—first clamping half—slot; 115—mounting pressure block; 1151—second clamping half—slot; 120—compression assembly; 121—compression frame; 1211—connecting hole; 122—silicone ring; 123—positioning pin; 130—first driving assembly; 131—first driving member; 132—lifting lead screw; 133—first master synchronous wheel; 134—first slave synchronous wheel; 135—first synchronous belt; 136—bearing seat; 137—guide post; 1371—limiting portion; 138—first fixed base; 139—lead screw nut; 1391—bearing; 140—second driving assembly; 141—second driving member; 142—second master synchronous wheel; 143—second slave synchronous wheel; 144—second synchronous belt; 145—second fixed base; 150—screen assembly; 151—printing screen; 1511—screen mounting plate; 152—screen cushion block; 1521—second mounting slot; 153—screen pressure block; 1531—third mounting slot; 154—glass support plate; 155—PVC sheet; 156—connecting member; 160—release film; 161—new release film; 162—old release film; 170—rack; 171—light source assembly; and 172—forming platform assembly.

### DESCRIPTION OF EMBODIMENTS

To make the above-mentioned objectives, features, and advantages of the present application clearer and more comprehensible, the implementation manners of the present application will be further described in detail below with reference to the accompanying drawings. In the following description, many details are set forth in order to provide a thorough understanding of the present application. However, the present application can be implemented in many other manners different from those described herein, and those skilled in the art can make similar improvements without departing from the essence of the present application. Therefore, the present application is not limited by the embodiments disclosed below.

In the description of the present application, it should be understood that the orientations or positional relationships indicated by the terms “center”, “longitudinal”, “transverse”, “length”, “width”, “thickness, “up”, “down”, “front”, “back”, “left”, “right”, “vertical”, “horizontal”, “top”, “bottom”, “inside”, “outside”, “clockwise”, “counter-clockwise”, “axial”, “radial”, “circumferential”, etc. are based on those shown in the accompanying drawings and intended only for the convenience of describing the present application and simplifying the description rather than for indicating or implying that the referred device or element must be provided with a particular orientation or constructed and operated in a particular orientation; therefore, they should not be construed as limiting the present application.

Furthermore, the terms “first” and “second” are intended only for descriptive purposes and should not be construed as indicating or implying their relative importance or implying the quantity of technical features indicated. Therefore, defining a feature with “first” and “second” can explicitly or implicitly indicate that at least one of such feature is included. In the description of the present application, “a plurality of” refers to at least two, for example, two or three, unless otherwise specifically defined.

In the present application, unless otherwise expressly specified and defined, the terms “mounted”, “attached”, “connected”, “fixed”, etc. should be understood in a broad sense, for example, a connection may be a fixed connection, a detachable connection, or an integral connection; it may be a mechanical connection or an electrical connection; it may be a direct connection or an indirect connection via an intermediate medium; and it may be a connection between two elements or an interaction between two elements, unless otherwise expressly defined For those of ordinary skill in the art, the specific meanings of the above terms in the present application can be understood on a case-by-case basis.

In the present application, unless otherwise expressly specified and defined, a first feature being “above” or “below” a second feature may indicate a direct contact between the first and second features or an indirect contact between the first and second features via an intermediate medium. Furthermore, a first feature being “above”, “over” or “on” a second feature may indicate that the first feature is directly or diagonally above the second feature, or simply indicate that the first feature is higher in level than the second feature. A first feature being “below”, “beneath” or “under” a second feature may indicate that the first feature is directly or diagonally beneath the second feature, or simply indicate that the first feature is lower in level than the second feature.

It should be noted that when an element is referred to as being “fixed to” or “disposed on” another element, it may be directly positioned on another element or there may be an additional element disposed therebeween. When an element is referred to as being “connected to” another element, it may be directly connected to another element or there may be an additional element disposed therebeween. The terms “vertical”, “horizontal”, “up”, “down”, “left”, “right”, and similar expressions used herein are for illustrative purposes only and do not represent the only implementation manner.

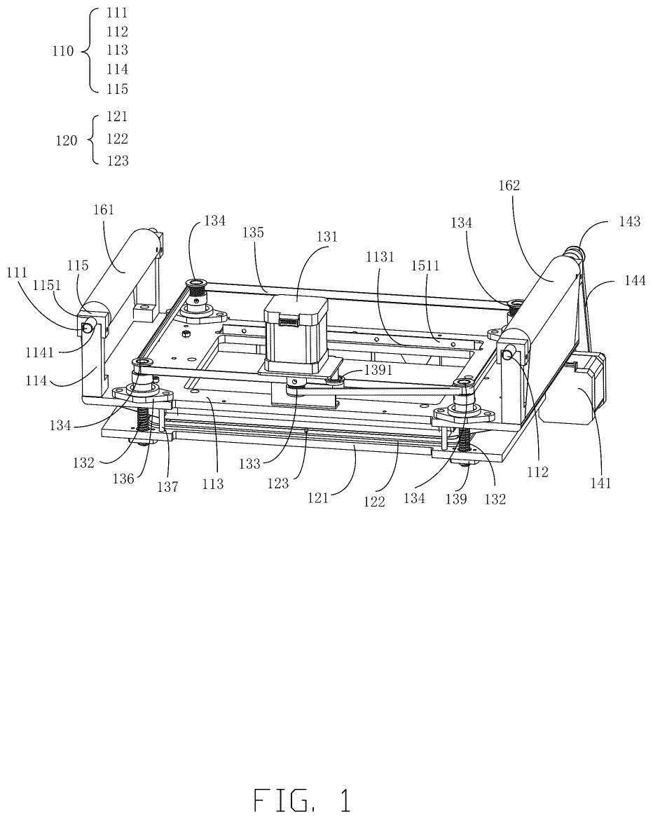

Referring to FIG. 1, which is a schematic diagram of a release film replacing device provided by an embodiment of the present application, the release film replacing device provided by the embodiment of the present application includes a winding assembly 110 and a compression assembly 120. The winding assembly 110 includes a first reel 111 and a second reel 112; the first reel 111 and the second reel 112 are oppositely spaced apart and both configured to be rotatably connected to a rack 170, the first reel 111 is configured to wind a first end of a release film 160, and the second reel 112 is configured to wind a second end of the release film 160; and when the second reel 112 rotates about an axis thereof along a first direction, the first end of the release film 160 is unwound relative to the first reel 111 and the second end of the release film 160 is wound relative to the second reel 112. Specifically, the first direction is a counterclockwise direction shown in FIG. 1.

The release film replacing device is installed on a 3D printing apparatus, a new release film 161 that has not been used is wound around the first reel 111, and an old release film 162 that has been used is wound around the second reel 112. During the use of the 3D printing apparatus, when it is found that the release film 160 is damaged or significantly worn and needs to be replaced, the first end of the release film 160 is unwound relative to the first reel 111 and the second end of the release film 160 is wound relative to the second reel 112, finally causing the release film 160 between the first reel 111 and the second reel 112 to be replaced with the new release film 161 on the first reel 111. The entire operation process is not only very simple and convenient but also very time-and labor-saving, avoiding the process of repeatedly disassembling and assembling a screen assembly 150.

In an embodiment, a user manually rotates the second reel 112 to cause the second reel 112 to rotate about an axis thereof along the first direction. In another embodiment, the second reel 112 is driven by a motor or a rotary cylinder to rotate about an axis thereof along the first direction.

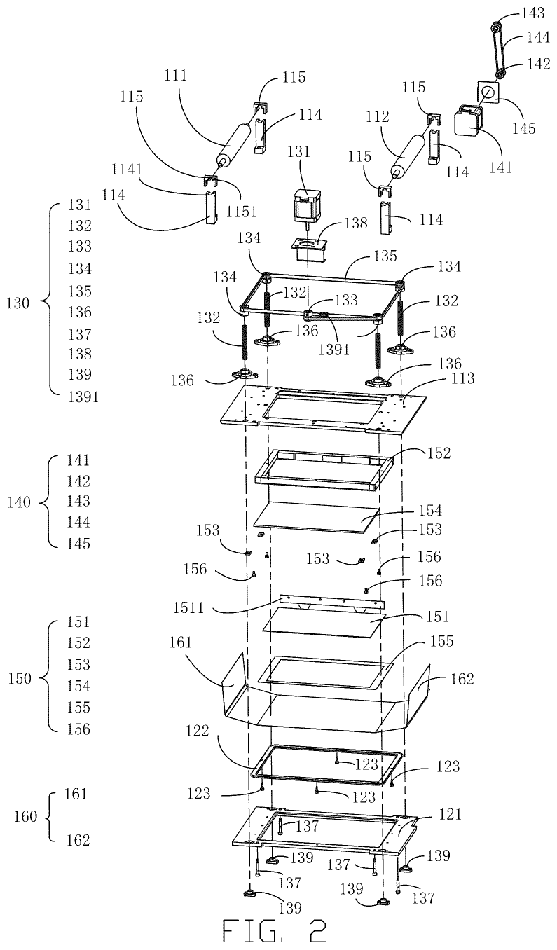

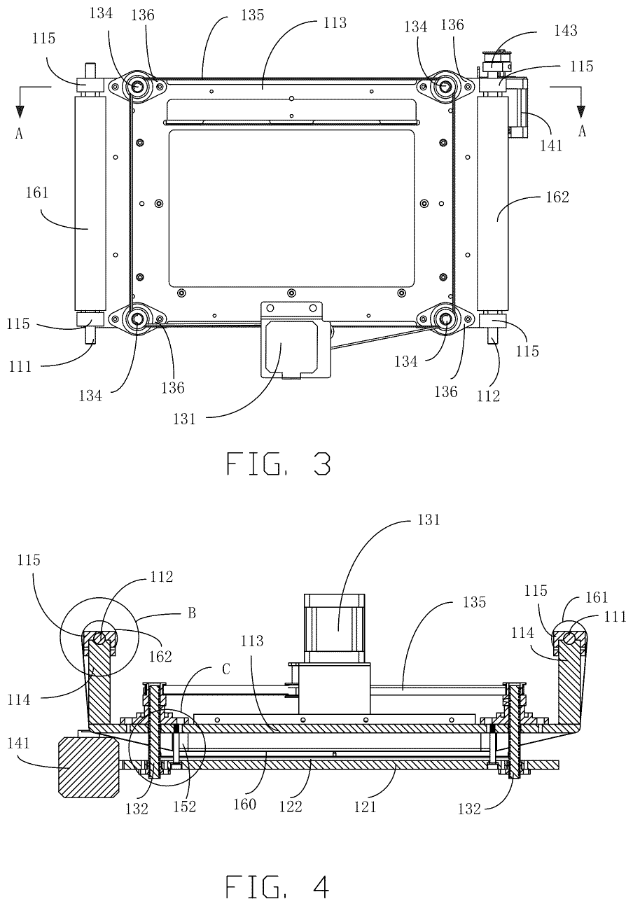

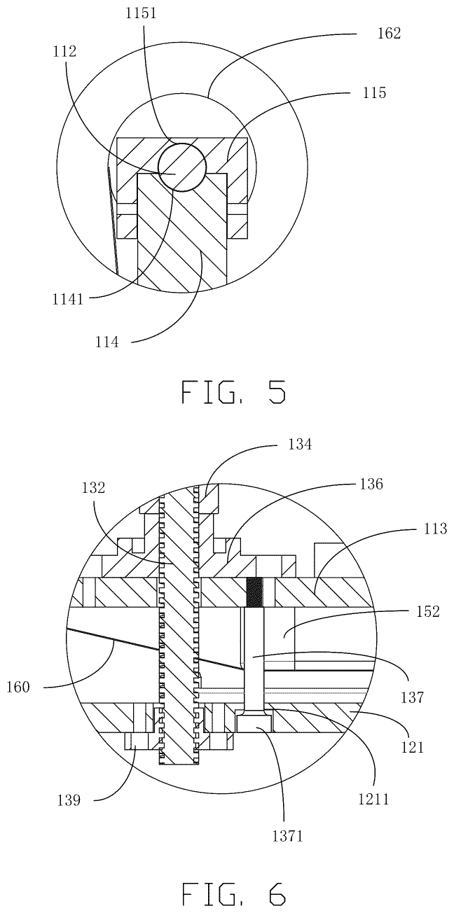

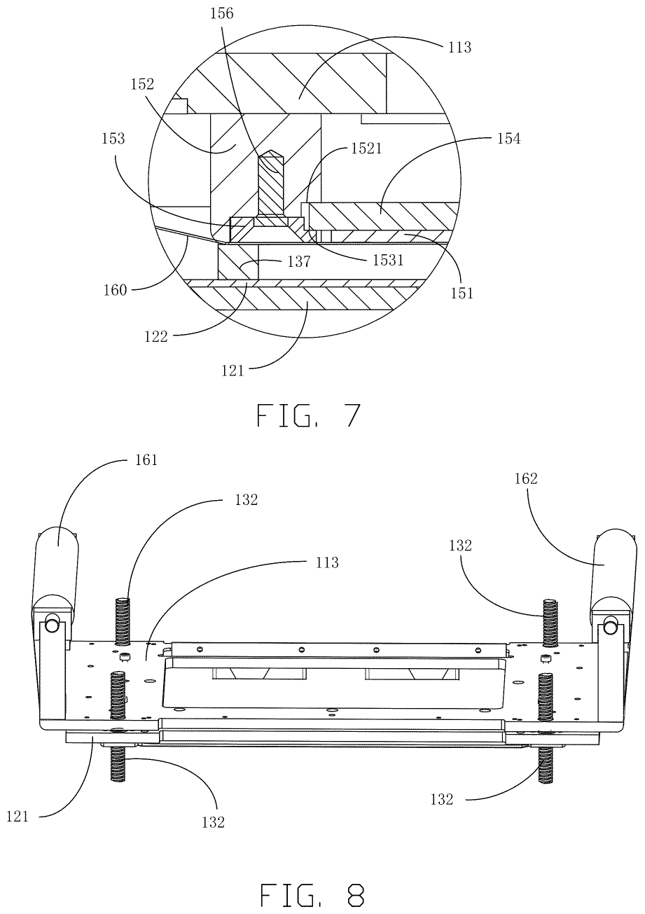

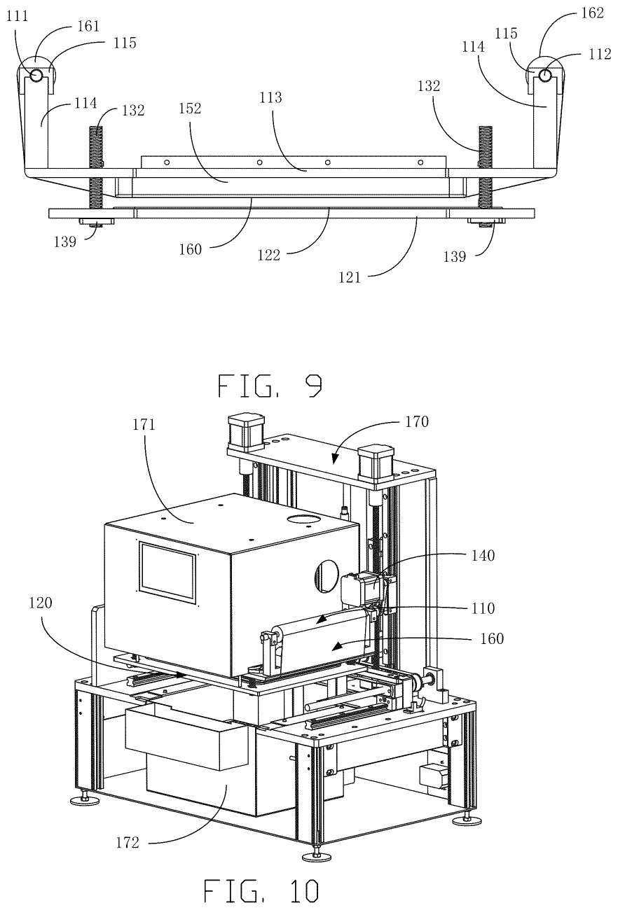

The structure of the release film replacing device will be described in detail below. Referring to FIGS. 2-10, FIG. 2 is an exploded view of the release film replacing device shown in FIG. 1; FIG. 3 is a top view of the release film replacing device shown in FIG. 1; FIG. 4 is an A-A sectional view of the release film replacing device shown in FIG. 3; FIG. 5 is an enlarged view of a partial structure B of the release film replacing device shown in FIG. 3; FIG. 6 is an enlarged view of a partial structure C of the release film replacing device shown in FIG. 3; FIG. 7 is a schematic diagram of mounting a screen cushion block 152, a screen pressure block 153, and a glass support plate 154 in the release film replacing device shown in FIG. 1; FIG. 8 is a schematic diagram of a compression assembly 120 in the release film replacing device shown in FIG. 1 moving close to a release film 160; FIG. 9 is a schematic diagram of the compression assembly 120 in the release film replacing device shown in FIG. 1 moving away from the release film 160; and FIG. 10 is a schematic diagram of mounting the release film replacing device shown in FIG. 1 on a 3D printing apparatus.

Referring to FIGS. 1, 2, and 5, the winding assembly 110 of the release film replacing device provided by an embodiment of the present application further includes a fixed plate 113 connected to the rack 170, and the first reel 111 and the second reel 112 are installed on the same side of the fixed plate 113; and the second end of the release film 160 is capable of passing over the fixed plate 113 and being wound around the second reel 112 via a side of the fixed plate 113 away from the first reel 111. Since the second end of the release film 160 passes over the fixed plate 113 and is wound around the second reel 112 via the side of the fixed plate 113 away from the first reel 111, the release film 160 is capable of being tensioned by the fixed plate 113 so that the release film 160 has a high flatness during the entire printing process and the model printing quality is also good.

In an embodiment, the second end of the release film 160 passes over an edge of the fixed plate 113 and is wound around the second reel 112 via the side of the fixed plate 113 away from the first reel 111. A roller is installed at the edge of the fixed plate 113 and the release film 160 is rollably connected to the roller. When the release film 160 is wound or unwound, the roller is capable of rotating about an axis thereof so that the contact between the release film 160 and the fixed plate 113 resulted from rolling friction, reducing the friction between the release film 160 and the fixed plate 113 and preventing the release film 160 from being scratched or damaged. In other embodiments, the roller can also be replaced with a soft material such as silicone or sponge.

In another embodiment, the fixed plate 160 is provided with an elongated hole extending along its width direction, the second end of the release film 160 extends through the elongated hole and is wound around the second reel 112 via the side of the fixed plate 113 away from the first reel 111. A roller is installed on a wall of the elongated hole, and the release film 160 extends through the elongated hole and is rollably connected to the roller installed on the wall. When the release film 160 is wound or unwound, the roller is capable of rotating about an axis thereof so that the contact between the release film 160 and the fixed plate 113 resulted from rolling friction, reducing the friction between the release film 160 and the fixed plate 113 and preventing the release film 160 from being scratched or damaged. In other embodiments, the roller can also be replaced with a soft material such as silicone or sponge.

It should be noted that there is no limitation on whether the second end of the release film 160 passes over the edge of the fixed plate 113 or extends through the elongated hole in the fixed plate 113, as long as the release film 160 is capable of being tensioned by the fixed plate 113 and not easily scratched or damaged.

Further referring to FIGS. 1, 2, and 5, the winding assembly 110 of the release film replacing device provided by an embodiment of the present application further includes a support arm 114 and a mounting pressure block 115. One side of the support arm 114 is fixedly connected to a side of the fixed plate 113 away from the release film 160, and the other side of the support arm 114 is provided with a first clamping half-slot 1141; the mounting pressure block 115 is connected to a side of the support arm 114 away from the fixed plate 113, and a side of the mounting pressure block 115 close to the support arm 114 is provided with a second clamping half-slot 1151; and the second clamping half-slot 1151 and the first clamping half-slot 1141 are capable of jointly forming an enclosed mounting cavity, and ends of the first reel 111 and the second reel 112 are capable of extending into the enclosed mounting cavity and being rotatably connected to a wall of the enclosed mounting cavity. By providing the support arm 114 with the first clamping half-slot 1141 and the mounting pressure block 115 with the second clamping half-slot 1151, the first reel 111 and the second reel 112 are capable of being rotatably connected to the wall of the enclosed mounting cavity jointly formed by the second clamping half-slot 1151 and the first clamping half-slot 1141 so that the first reel 111 and the second reel 112 are suspended from the fixed plate 113, thereby not only winding more release films 160 but also rotating more smoothly about an axis thereof.

In an embodiment, the first reel 111 further includes a damper to prevent it from rotating about an axis, and only when the second reel 112 rotates about an axis thereof can the first reel 111 be driven by the release film 160 to rotate about an axis thereof and perform an unwinding operation so that the release film 160 is less likely to get loose under the tension effect of the first reel 111 and the second reel 112.

Further referring to FIGS. 1, 2, 4, 6, 7, and 9, the release film replacing device provided by an embodiment of the present application further includes a compression assembly 120. The compression assembly 120 is arranged on a side of the release film 160 away from the winding assembly 110 and connected to the fixed plate 113; and the compression assembly 120 is capable of moving close to or far away from the release film 160.

A side of the release film 160 away from the fixed plate 113 is compressed by the compression assembly 120 so that the release film 160 is tensioned and the release film 160 below the fixed plate 113 is located in the same horizontal plane, thereby achieving higher flatness, better light transmittance, and more satisfactory quality of printed models. When the release film 160 needs to be replaced during use, the compression assembly 120 is moved away from the release film 160 so that the release film 160 is separated from the compression assembly 120. When the release film 160 is completely separated from the compression assembly 120, the compression assembly 120 controls the winding assembly 110 to cause the second reel 112 to rotate about an axis thereof along a first direction, thereby finally completing the replacement of the release film 160.

Referring to FIGS. 1, 2, 4, 6, 8, and 9, the compression assembly 120 of the release film replacing device provided by an embodiment of the present application includes a compression frame 121; the release film replacing device further includes a first driving assembly 130 installed on the fixed plate 113 and connected to the compression frame 121; and the first driving assembly 130 is configured to drive the compression frame 121 to move close to or farther away from the release film 160. When the release film 160 needs to be replaced, the first driving assembly 130 drives the compression frame 121 to move away from an old release film 162 that has been used, thereby finally causing the compression frame 121 to be separated from the old release film 162. At this time, the second reel 112 is rotated along the first direction so that the old release film 162 between the first reel 111 and the second reel 112 is wound onto the second reel 112 under the rotation of the second reel 112, and a new release film 161 on the first reel 111 is rotated between the first reel 111 and the second reel 112. After the rotation of the new release film 161 is completed, the compression frame 121 is driven by the first driving assembly 130 to move close to the new release film 161 so that the new release film 161 is compressed and flattened by the compression frame 121 to proceed with a model printing operation.

In an embodiment, the first driving assembly 130 can be a linear motor drive and, in other embodiments, can also be a belt drive or a lead screw drive, which is not limited thereto, as long as the first driving assembly 130 is capable of driving the compression frame 121 to move close to or farther away from the release film 160.

Referring to FIGS. 1, 2, 4, 6, 8, and 9, the first driving assembly 130 of the release film replacing device provided by an embodiment of the present application includes a first driving member 130, a lead screw nut 139, and a lifting lead screw 132; the first driving member 131 is installed on the fixed plate 113, the lead screw nut 139 is fixedly connected to the compression frame 121, one end of the lifting lead screw 132 is connected to a power take-off end of the first driving member 131, and the other end of the lifting lead screw 132 extends through the lead screw nut 139 and is threadedly connected thereto; and the first driving member 131 is configured to drive the lifting lead screw 132 to rotate about an axis thereof, so as to drive the compression frame 121 to move close to or farther away from the release film 160.

When the release film 160 needs to be replaced, the first driving member 131 drives the lifting lead screw 132 to rotate about an axis thereof and the lead screw nut 139 moves up and down relative to a height direction of the lifting lead screw 132 so that the compression frame 121 is driven to move away from an old release film 162 that has been used, thereby finally causing the compression frame 121 to be separated from the old release film 162. At this time, the second reel 112 is rotated along the first direction so that the old release film 162 between the first reel 111 and the second reel 112 is wound onto the second reel 112 under the rotation of the second reel 112, and a new release film 161 on the first reel 111 is rotated between the first reel 111 and the second reel 112. After the rotation of the new release film 161 is completed, the compression frame 121 is driven by the lifting lead screw 132 to move close to the new release film 161 so that the new release film 161 is compressed and flattened by the compression frame 121 to proceed with a model printing operation. In an embodiment, the lead screw nut 139 is a T-nut. Specifically, the first driving member 131 is installed on the fixed plate 113 through a first fixed base 138.

In an embodiment, the first driving member 131 is a motor which drives the lifting lead screw 132 to rotate about an axis thereof. In other embodiments, the first driving member 131 can also be a rotary cylinder or the like, which is not limited thereto.

Referring to FIGS. 1-4 and 8-9, the release film replacing device provided by an embodiment of the present application has a plurality of lifting lead screws 132, and the plurality of lifting lead screws 132 are spaced apart along length and width directions of the fixed plate 113. The first driving assembly 130 further includes a synchronous mechanism installed on the fixed plate 113, the synchronous mechanism is connected to the first driving member 131 and each of the plurality of lifting lead screws 132, and each of the plurality of lifting lead screws 132 is capable of being driven by the synchronous mechanism to rotate about an axis thereof.

Since the plurality of lifting lead screws 132 are spaced apart along the length and width directions of the fixed plate 113, the compression frame 121 is capable of being connected to the plurality of lifting lead screws 132 and the force on the compression frame 121 is relatively balanced. When the compression frame 121 moves close to or farther away from the release film 160, the movement process is relatively smooth, and warping or flipping is less likely to occur. In an embodiment, the number of the lifting lead screws 132 is four and the four lifting lead screws 132 are arranged along four corners of the fixed plate 113 so that the compression frame 121 moves very smoothly. In other embodiments, the number of the lifting lead screws 132 can also be six, eight, etc., which is not limited thereto, and can be adaptively modified according to the weight and size of the compression frame 121.

Referring to FIGS. 1 and 2, the synchronous mechanism of the release film replacing device provided by an embodiment of the present application includes a first master synchronous wheel 133, a plurality of first slave synchronous wheels 134, and a first synchronous belt 135. The first master synchronous wheel 133 and the plurality of first slave synchronous wheels 134 are spaced apart, the first master synchronous wheel 133 is sleeved and fixed on the power take-off end of the first driving member 131, each of the plurality of first slave synchronous wheels 134 is sleeved and fixed on an end of one of the lifting lead screws 132 away from the compression frame 121, the first master synchronous wheel 133 and the plurality of first slave synchronous wheels 134 are capable of tensioning the first synchronous belt 135 and driving the first synchronous belt 135 to make a closed circular motion along a second direction. Specifically, the second direction is a clockwise or counterclockwise direction shown in FIG. 3. The up and down movement of the plurality of lifting lead screws 132 is controlled through the transmission of the first master synchronous wheel 133, the plurality of first slave synchronous wheels 134, and the first synchronous belt 135 so that not only the plurality of lifting lead screws 132 are driven by the same driving member, which is more economical, but also the transmission is smoother with low noise during the transmission process. In an embodiment, the number of the first slave synchronous wheels 134 is four, which is adapted to the number of the lifting lead screws 132.

Referring to FIGS. 1 and 2, the release film replacing device provided by an embodiment of the present application further includes a bearing 1391, the first fixed plate 113 is provided with a mounting post, and the mounting post and the power take-off end of the first driving member 131 are spaced apart; the bearing 1391 is sleeved and fixed on the mounting post; and the first synchronous belt 135 is wound around the first master synchronous wheel 133 and the bearing 1391 in an S shape. Since the first synchronous belt 135 is wound around the first master synchronous wheel 133 and the bearing 1391 in an S shape, the contact area between the first master synchronous wheel 133 and the first synchronous belt 135 is increased, thereby reducing slipping between the first synchronous belt 135 and the first master synchronous wheel 133. In an embodiment, the bearing 1391 is a deep groove ball bearing. Since the deep groove ball bearing has a small friction coefficient, high limit speed, simple structure, low manufacturing cost, high precision, no need for regular maintenance, large size range, and many forms, the manufacturing cost of the release film replacing device is relatively low.

Referring to FIGS. 1-3 and 6, the first driving assembly 130 of the release film replacing device provided by an embodiment of the present application further includes a bearing seat 136 arranged between the fixed plate 113 and the first slave synchronous wheel 134 and installed on the fixed plate 113, and the lifting lead screw 132 extends through the bearing seat 136 and is connected by interference fit to an inner wall of the bearing seat 136. By providing the bearing seat 136, the friction between the lifting lead screw 132 and the fixed plate 113 is small, and when the lifting lead screw 132 drives the compression frame 121 to move, the entire transmission process is relatively smooth and labor-saving.

Referring to FIGS. 1, 2, 4, and 6, the first driving assembly 130 of the release film replacing device provided by an embodiment of the present application further includes a guide member connected between the fixed plate 113 and the compression frame 121, the compression frame 121 is slidably connected to the guide member, and when the compression frame 121 moves close to or farther away from the release film 160, the compression frame 121 is capable of sliding relative to the guide member. When the lifting lead screw 132 drives the compression frame 121 to move, the entire movement process is more stable under the guidance of the guide member.

In an embodiment, the guide member can be a combination of a guide rail and a slider. The guide rail is installed between the fixed plate 113 and the compression frame 121, the compression frame 121 is installed on the slider, and when the compression frame 121 moves close to or farther away from the release film 160, the slider slides on the guide rail, thereby guiding the movement of the compression frame 121. In an embodiment, the guide member can also be a guide post passing through the compression frame 121, and the compression frame 121 is capable of sliding relative to the guide post. It should be noted that there is no limitation on the shape and structure of the guide member, as long as it can play a guide role when the compression frame 121 slides relative to the fixed plate 113.

Referring to FIGS. 1, 2, 4, and 6, the guide member of the release film replacing device provided by an embodiment of the present application is a guide post 137, and one end of the guide post 137 is fixedly connected to the fixed plate 113; the compression frame 121 is provided with a connecting hole 1211 through which the other end of the guide post 137 passes and is slidably connected to a wall of the connecting hole 1211; and a side of the guide post 137 away from the fixed plate 113 is provided with a limiting portion 1371 protruding along a radial direction thereof, and the limiting portion 1371 overlaps a side of the compression frame 121 away from the fixed plate 113. By providing the limiting portion 1371 on the guide post 137, the maximum distance of the compression frame 121 moving away from the release film 160 is limited so that the compression frame 121 is less likely to separate from the lifting lead screw 132 and the safety and stability of the entire release film replacing device is improved. When the lifting lead screw 132 drives the compression frame 121 to move, the entire movement process is more stable under the guidance of the guide post 137. In an embodiment, the cross-section of the limiting portion 1371 is an annular structure and, in other embodiments, can also be a cross-shaped or star-shaped structure, which is not limited thereto.

Referring to FIGS. 1, 2, 4, and 7, the compression assembly 120 of the release film replacing device provided by an embodiment of the present application further includes a silicone ring 122 fixedly connected to a side of the compression frame 121 close to the release film 160, and a side of the silicone ring 122 away from the compression frame 121 is configured to compress the release film 160. By providing the silicone ring 122, after the release film 160 is compressed and flattened, the friction between the release film 160 and the silicone ring 122 is large so that the release film 160 will not get loose by itself and the gap between the release film 160 and the compression frame 121 is reduced.

The compression assembly 120 of the release film replacing device provided by an embodiment of the present application further includes a positioning pin 123, one end of the positioning pin 123 is fixedly connected to the compression frame 121, and the other end of the positioning pin 123 extends through the silicone ring 122 and a positioning hole in the release film 160. Since the positioning pin 123 is provided to pass through the silicone ring 122 and be inserted into the positioning hole drilled in advance in the release film 160, the positioning accuracy of the release film 160 is relatively high. In an embodiment, the number of the positioning pins 123 is four, and the four positioning pins 123 are respectively arranged on the four sides of the compression frame 121 and adapted to the position of the positioning hole drilled in advance in the release film 160. In other embodiments, the number of the positioning pins 123 can also be two, six, etc., which is not limited thereto.

Referring to FIGS. 1-4, the release film replacing device provided by an embodiment of the present application further includes a second driving assembly 140, and the second driving assembly 140 is installed on the fixed plate 113, connected to an end of the second reel 112, and capable of driving the second reel 112 to rotate about an axis thereof along the first direction. By providing the second driving assembly 140, when the release film 160 needs to be replaced, after the first driving assembly 130 drives the compression frame 121 to move away from the release film 160, the second driving assembly 140 drives the second reel 112 to rotate about an axis thereof along the first direction, thereby achieving the replacement of the release film 160. In an embodiment, the second driving assembly 140 is a motor drive which drives the second reel 112 to rotate about an axis thereof through the rotation of a power take-off shaft of the motor. In other embodiments, the second driving assembly 140 can also be a rotary cylinder drive, which is not limited thereto, as long as it is capable of driving the second reel 112 to rotate about an axis thereof.

Referring to FIG. 2, the second driving assembly 140 of the release film replacing device provided by an embodiment of the present application includes a second driving member 141, a second master synchronous wheel 142, a second slave synchronous wheel 143, and a second synchronous belt 144. The second driving member 141 is installed on the fixed plate 113, the second master synchronous wheel 142 and the second slave synchronous wheel 143 are oppositely spaced apart, the second master synchronous wheel 142 is sleeved and fixed on a power take-off end of the second driving member 141, and the second slave synchronous wheel 143 is sleeved and fixed on an end of the second reel 112; and the second master synchronous wheel 142 and the second slave synchronous wheel 143 are capable of tensioning the second synchronous belt 144 and being driven by the second driving member 141 to drive the second synchronous belt 144 to make a closed circular motion along the first direction. The rotation of the second reel 112 about an axis thereof is controlled through the transmission of the second driving member 141, the second master synchronous wheel 142, the second slave synchronous wheel 143, and the second synchronous belt 144 so that the second reel 112 rotates smoothly with low noise. In an embodiment, the second driving member 141 is fixedly connected to the fixed plate 113 through a second fixed base 145. In an embodiment, the second driving member 141 is a motor which drives the second reel 112 to rotate about an axis thereof. In other embodiments, the second driving member 141 can also be a rotary cylinder or the like, which is not limited thereto.

It should be noted that a user can calculate the wear time of the release film 160 so that the device automatically replaces the release film 160 regularly. For example, after 100 hours of printing, the first driving assembly 130 and the second driving assembly 140 are automatically driven to replace the release film 160. Alternatively, during the printing process, when the user observes that the release film 160 has been worn, the first driving assembly 130 and the second driving assembly 140 are manually driven to replace the release film 160.

The release film replacing device provided by an embodiment of the present application further includes a controller, and the controller is connected to the compression assembly 120 and the second driving assembly 140; and when the compression assembly 120 moves away from the release film 160, the controller controls the second driving assembly 140 to drive the second reel 112 to rotate about an axis thereof along the first direction. By providing the controller, when the compression assembly 120 moves away from the release film 160, the second driving assembly 140 controls the second reel 112 to rotate about an axis thereof, thereby achieving the automatic replacement of the release film 160 without the need of manual observation and control of the start-up time of the second driving assembly 140.

Referring to FIGS. 1 and 2, the release film replacing device provided by an embodiment of the present application further includes a screen assembly 150, and the screen assembly 150 is arranged between the release film 160 and the fixed plate 113 and includes a printing screen 151; and a side of the printing screen 151 is provided with a screen mounting plate 1511 protruding along a thickness direction thereof, a first mounting slot 1131 is formed in the fixed plate 113, and the screen mounting plate 1511 is capable of being inserted into the first mounting slot 1131 and fixedly connected to a wall of the first mounting slot 1131. Through the fixed connection between the screen mounting plate 1511 on the printing screen 151 and the wall of the first mounting slot 1131 in the fixed plate 113, the printing screen 151 is connected to the fixed plate 113. In an embodiment, the printing screen 151 is a 4K printing screen.

Referring to FIGS. 2 and 7, the screen assembly 150 of the release film replacing device provided by an embodiment of the present application further includes a screen cushion block 152, a glass support plate 154, and a screen pressure block 153 arranged in sequence along a vertical direction, and the screen cushion block 152, the glass support plate 154, and the screen pressure block 153 are disposed between the printing screen 151 and the fixed plate 113; and one side of the screen cushion block 152 is fixedly connected to the fixed plate 113, the other side of the screen cushion block 152 is fixedly connected to the screen pressure block 153, and the glass support plate 154 is capable of being pressed by the screen pressure block 153 against the screen cushion block 152. The screen cushion block 152 and the screen pressure block 153 enable the glass support plate 154 to be arranged above the printing screen 151. Since the fixed plate 113 has a hollow frame structure, the glass support plate 154 is capable of protecting the printing screen 151 from easy direct contact with the light source above the fixed plate 113 or foreign matters, and the printing screen 151 is not prone to scratches and damage.

Referring to FIGS. 2 and 7, the screen assembly 150 of the release film replacing device provided by an embodiment of the present application further includes a connecting member 156, one end of the connecting member 156 is connected to the screen pressure block 153, and the other end of the connecting member 156 extends through and is fixedly connected to the screen cushion block 152 so that the glass support plate 154 is pressed by the screen pressure block 153 against the screen cushion block 152.

Further referring to FIG. 7, for the release film replacing device provided by an embodiment of the present application, a second mounting slot 1521 is formed on a side of the screen cushion block 152 close to the screen pressure block 153, a third mounting slot 1531 is formed on a side of the screen pressure block 153 close to the screen cushion block 152, and side edges of the glass support plate 154 are capable of being accommodated and clamped in the second mounting slot 1521 and the third mounting slot 1531. The second mounting slot 1521 and the third mounting slot 1531 are used to accommodate the side edges of the glass support plate 154 so that a chipping risk of the glass support plate 154 is less likely to occur, thereby reducing damage to the glass support plate 154 when the glass support plate 154 is connected by bolts or other manners.

Referring to FIG. 2, the screen assembly 150 of the release film replacing device provided by an embodiment of the present application further includes a PVC sheet 155 arranged on a side of the printing screen 151 away from the screen pressure block 153 and connected to the printing screen 151. The PVC sheet 155 is capable of blocking the interference light generated by the light source so that the printing material formed by light curing under the release film 160 is not easily affected by the ultraviolet light projected from the edges of the printing screen 151, thereby improving the printing accuracy of the entire model.

Referring to FIG. 10, the present application further provides a 3D printing apparatus including the above-mentioned release film replacing device and a rack 170, and the release film replacing device is slidably connected to the rack 170. When the release film 160 needs to be replaced during a printing process of the 3D printing apparatus, the replacement operation can be implemented through the release film replacing device. The entire operation process is not only very simple and convenient but also very time-and labor-saving, avoiding the process of repeatedly disassembling and assembling the screen assembly 150.

Further referring to FIG. 10, the 3D printing apparatus provided by the present application further includes a light source assembly 171 capable of emitting ultraviolet light, and a forming platform assembly 172, including a forming platform and a filament tank carrying a printing material. In some embodiments, the printing material is a liquid photosensitive resin. During the 3D printing process, the ultraviolet light emitted by the light source assembly 171 is capable of being projected onto the forming platform in the forming platform assembly 172 through the screen assembly 150 and the release film 160, and the printing material is formed by light curing layer by layer between the forming platform and the release film 160, thereby finally formed into the required model.

In some other embodiments, the printing material is zirconia ceramic slurry cured between the forming platform and the release film under the irradiation of an ultraviolet light source to obtain a zirconia ceramic embryo, and then the obtained zirconia ceramic embryo is degreased and sintered in sections to obtain a 3D printed model of the ceramic material. In an embodiment, the percentage content of each component in the zirconia ceramic slurry is as follows: zirconia powder: 90˜94 wt %, disperser: 1.5˜2.5%, photoinitiator: 0.6˜1%, and the remainder is premixed solution. The disperser is any one of DISPERBYK-110, DISPERBYK-W969, and DISPERBYK-2020, and the photoinitiator is phenylbis(2,4,6-trimethylbenzoyl)phosphine oxide (TPO).

In other embodiments, the printing material can also be other types of ceramic materials, such as metal tin-reinforced nano-TiO2 light-cured 3D printing ceramic slurry and piezoelectric and ferroelectric 3D printing ceramic slurry, which is not limited thereto and can be adaptively modified according to the material of the 3D model to be printed. It can be seen that by installing the protective case 200 provided by the present application on the 3D printing apparatus for 3D printing, 3D printing of both conventional photosensitive resin materials and ceramic materials can be achieved.

Beneficial effects of the present application:

The release film replacing device provided by the present application is configured to be installed on the 3D printing apparatus, a new release film that has not been used is wound around the first reel, and an old release film that has been used is wound around the second reel. During the use of the 3D printing apparatus, when it is found that the release film is damaged or significantly worn and needs to be replaced, the second reel rotates about an axis thereof along a first direction to cause a first end of the release film to be unwound relative to the first reel and a second end of the release film to be wound relative to the second reel, finally causing the release film between the first reel and the second reel to be replaced with a new release film on the first reel. The entire operation process is not only very simple and convenient but also very time-and labor-saving, avoiding the process of repeatedly disassembling and assembling the screen assembly.

The technical features of the above embodiments can be combined in any way. To simplify the description, not all possible combinations of the technical features in the above embodiments are described. However, as long as there is no contradiction in the combinations of these technical features, all possible combinations should be considered to fall within the scope of the specification.

The above embodiments only represent several implementation manners of the present application, and the description thereof is relatively specific and detailed but should not be construed as limiting the scope of the present application. It should be noted that for those of ordinary skill in the art, several modifications and improvements can be made without departing from the concept of the present application and these modifications and improvements should all fall within the protection scope of the present application. Therefore, the protection scope of the present application shall be subject to the appended claims.

1. A release film replacing device, wherein the release film replacing device comprising:
a winding assembly, the winding assembly comprises a first reel and a second reel; the first reel and the second reel are oppositely spaced apart and both configured to be rotatably connected to a rack, the first reel is configured to wind a first end of a release film, and the second reel is configured to wind a second end of the release film; and
when the second reel rotates about an axis of the second reel along a first direction, the first end of the release film is unwound relative to the first reel and the second end of the release film is wound relative to the second reel.

2. The release film replacing device of claim 1, wherein the winding assembly further comprises a fixed plate connected to the rack, and the first reel and the second reel are installed on a same side of the fixed plate; and the second end of the release film is capable of passing over the fixed plate and being wound around the second reel via a side of the fixed plate away from the first reel.

3. The release film replacing device of claim 2, wherein the release film replacing device further comprises a compression assembly arranged on a side of the release film away from the winding assembly, the compression assembly being connected to the fixed plate, and is movable closes to or farther away from the release film.

4. The release film replacing device of claim 3, wherein the compression assembly comprises a compression frame; and
the release film replacing device further comprises a first driving assembly installed on the fixed plate and connected to the compression frame; and the first driving assembly is configured to drive the compression frame to move close to or farther away from the release film.

5. The release film replacing device of claim 4, wherein the first driving assembly comprises a first driving member, a lead screw nut, and at least one lifting lead screw; and
the first driving member is installed on the fixed plate, the lead screw nut is fixedly connected to the compression frame, one end of the at least one lifting lead screw is connected to a power take-off end of the first driving member, and another end of the at least one lifting lead screw extends through the fixed plate and is threadedly connected to the lead screw nut; and the first driving member is configured to drive the at least one lifting lead screw to rotate about an axis of the at least one lifting lead screw, so as to drive the compression frame to move close to or farther away from the release film.

6. The release film replacing device of claim 5, wherein the first driving assembly comprises a plurality of lifting lead screws, and the plurality of lifting lead screws is spaced apart along length and width directions of the fixed plate; and
the first driving assembly further comprises a synchronous mechanism installed on the fixed plate, the synchronous mechanism is connected to the first driving member and each of the plurality of lifting lead screws, and each of the plurality of lifting lead screws is configured to be driven by the synchronous mechanism to rotate about an axis of the lifting lead screw.

7. The release film replacing device of claim 6, wherein the synchronous mechanism comprises a first master synchronous wheel, a plurality of first slave synchronous wheels, and a first synchronous belt; and
the first master synchronous wheel and the plurality of first slave synchronous wheels are spaced apart, the first master synchronous wheel is sleeved and fixed on the power take-off end of the first driving member, each of the plurality of first slave synchronous wheels is sleeved and fixed on an end of a corresponding one of the plurality of lifting lead screws away from the compression frame, the first master synchronous wheel and the plurality of first slave synchronous wheels are configured to tension the first synchronous belt and driving the first synchronous belt to make a closed circular motion along a second direction.

8. The release film replacing device of claim 4, wherein the first driving assembly further comprises a guide member connected between the fixed plate and the compression frame, the compression frame is slidably connected to the guide member, and when the compression frame moves close to or farther away from the release film, the compression frame is slidable relative to the guide member.

9. The release film replacing device of claim 4, wherein the compression assembly further comprises a silicone ring fixedly connected to a side of the compression frame close to the release film, and a side of the silicone ring away from the compression frame is configured to compress the release film.

10. The release film replacing device of claim 9, wherein the compression assembly further comprises a positioning pin, one end of the positioning pin is fixedly connected to the compression frame, and another end of the positioning pin extends through the silicone ring and a positioning hole in the release film.

11. The release film replacing device of claim 3, wherein the release film replacing device further comprises a second driving assembly installed on the fixed plate, the second driving assembly being connected to an end of the second reel, and configured to drive the second reel to rotate about an axis of the second reel along the first direction.

12. The release film replacing device of claim 11, wherein the second driving assembly comprises a second driving member, a second master synchronous wheel, a second slave synchronous wheel, and a second synchronous belt; and
the second driving member is installed on the fixed plate, the second master synchronous wheel and the second slave synchronous wheel are oppositely spaced apart, the second master synchronous wheel is sleeved and fixed on a power take-off end of the second driving member, and the second slave synchronous wheel is sleeved and fixed on an end of the second reel; and the second master synchronous wheel and the second slave synchronous wheel are configured to tension the second synchronous belt and being driven by the second driving member to drive the second synchronous belt to make a closed circular motion along the first direction.

13. The release film replacing device of claim 11, wherein the release film replacing device further comprises a controller connected to the compression assembly and the second driving assembly; and
when the compression assembly moves away from the release film, the controller controls the second driving assembly to drive the second reel to rotate about an axis of the second reel along the first direction.

14. The release film replacing device of claim 2, wherein the release film replacing device further comprises a screen assembly, wherein the screen assembly is arranged between the release film and the fixed plate and comprises a printing screen; and a side of the printing screen is provided with a screen mounting plate protruding along a thickness direction of the printing screen, a first mounting slot is formed in the fixed plate, and the screen mounting plate is insertable into the first mounting slot and fixedly connected to a wall of the first mounting slot.

15. The release film replacing device of claim 14, wherein the screen assembly further comprises a screen cushion block, a glass support plate, and a screen pressure block arranged in above described sequence along a vertical direction, and the screen cushion block, the glass support plate, and the screen pressure block are disposed between the printing screen and the fixed plate; and one side of the screen cushion block is fixedly connected to the fixed plate, another side of the screen cushion block is fixedly connected to the screen pressure block, and the glass support plate is pressable by the screen pressure block against the screen cushion block.

16. The release film replacing device of claim 15, wherein a second mounting slot is formed on a side of the screen cushion block close to the screen pressure block, a third mounting slot is formed on a side of the screen pressure block close to the screen cushion block, and side edges of the glass support plate are accommodable and clamped in the second mounting slot and the third mounting slot.

17. The release film replacing device of claim 15, wherein the screen assembly further comprises a PVC sheet arranged on a side of the printing screen away from the screen pressure block and connected to the printing screen.

18. A 3D printing apparatus, wherein the 3D printing apparatus comprises a release film replacing device and a rack, wherein the release film replacing device is slidably connected to the rack; and
the release film replacing device comprises a winding assembly, the winding assembly comprises a first reel and a second reel; the first reel and the second reel are oppositely spaced apart and both configured to be rotatably connected to a rack, the first reel is configured to wind a first end of a release film, and the second reel is configured to wind a second end of the release film;
when the second reel rotates about an axis of the second reel along a first direction, the first end of the release film is unwound relative to the first reel and the second end of the release film is wound relative to the second reel.

19. The 3D printing apparatus of claim 18, wherein the winding assembly further comprises a fixed plate connected to the rack, and the first reel and the second reel are installed on a same side of the fixed plate; and the second end of the release film is capable of passing over the fixed plate and being wound around the second reel via a side of the fixed plate away from the first reel.

20. The 3D printing apparatus of claim 19, wherein the release film replacing device further comprises a screen assembly, wherein the screen assembly is arranged between the release film and the fixed plate and comprises a printing screen; and a side of the printing screen is provided with a screen mounting plate protruding along a thickness direction of the printing screen, a first mounting slot is formed in the fixed plate, and the screen mounting plate is insertable into the first mounting slot and fixedly connected to a wall of the first mounting slot.
